(19) United States
(12) Patent Application Publication
(10) Pub. No.: US 2019/0154244 A1
(43) Pub. Date: May 23, 2019

(54) LED-RETROFIT LIGHTING DEVICE HAVING DETACHABLE CONTROL MODULE

(71) Applicant: PHILIPS LIGHTING HOLDING B.V., EINDHOVEN (NL)

(72) Inventors: Yichong ZENG, EINDHOVEN (NL); Sturgis KYLE, EINDHOVEN (NL); Michael ZHANG, EINDHOVEN (NL)

(21) Appl. No.: 15/758,145

(22) PCT Filed: Aug. 3, 2017
(86) PCT No.: PCT/EP2017/069626

§ 371 Date: Mar. 7, 2018

(30) Foreign Application Priority Data
Aug. 12, 2016 (US) 62374546
Sep. 29, 2016 (EP) 16191552.5

(51) Int. Cl. F21V 23/04; F21K 9/232; F21V 23/06; F21K 9/238

(52) U.S. Cl. CPC F21V 23/0435; F21K 9/232; F21V 23/0464; F21Y 2115/10; F21V 23/06; F21K 9/238; F21V 23/0471

(57) ABSTRACT

The present disclosure provides an LED retrofit lighting device. The LED retrofit lighting device includes a light emitting assembly, a mounting interface at a bottom portion of the light emitting assembly, a receptacle at a top portion of the light emitting assembly, the receptacle having a plurality of electrical contact points, and a control module detachably coupled to the receptacle. The LED retrofit lighting device is suitably sized to be completely enclosed within the chamber space of a decorative lighting fixture.

### TECHNICAL FIELD

The present disclosure relates to a light emitting diode (LED) retrofit lighting device. More particularly, the present disclosure relates to an LED retrofit lighting device having a detachable control module which has control and connectivity functionality.

### BACKGROUND

Lighting fixtures using LED retrofit lamp or LED retrofit module have become more and more popular recently. Because LEDs have better energy efficiency than conventional High-Intensity Discharge (HID) solutions, LED solutions have begun to penetrate in the outdoor lighting market.

With the development of Internet of Things (IoT) technology, remote control or connected lighting solutions have gained more attention in outdoor lighting applications. Some lighting products and solutions in the market place can already achieve such remote control or connectivity function, such as, the CityTouch solution of Philips, the ROAM system of Acuity, and LightGrid Outdoor Wireless Control System of GE. These solutions, however, require modification on the existing lighting fixture or a new LED fixture with a control module integrated therein. As such, these solutions not only require the purchase of a new lighting fixture, but also have limited ability to upgrade as technology advances. For existing lighting infrastructures, such as decorative lighting fixtures, these solutions have only limited applications.

Other solutions may have individual control modules that can be installed from outside of the lighting fixture. For example, a National Electrical Manufacturers Association (NEMA) socket based photo-cell module may be installed on top of a lighting fixture, or at any other locations external to the lighting fixture, so as to detect the ambient light from outside of the lighting fixture. Such solution, however, may have negative impacts on the appearance of the lighting fixture, which is an important concern for decorative lighting fixtures, such as post tops.

For decorative lighting fixtures, there is a strong desire to keep the original design of the decorative fixtures due to, for example, their historical, cultural, or other considerations. Accordingly, LED retrofit solutions are by far more preferable for such applications. Therefore, there is a need to develop a connected retrofit solution for the existing lighting infrastructure.

### SUMMARY

One objective of the present disclosure is to provide a solution such that a customer does not need to buy a new lighting fixture. Instead, a customer can simply purchase an LED retrofit lamp or module configured with the means to control the LED retrofit lamp or module remotely via, for example, wireless technology.

Another objective of the present disclosure is to provide an internal LED retrofit solution with wireless control functions for any existing fixtures, without modification to the lighting fixture (i.e., no change in the external appearance of the lighting feature).

A further objective of the present disclosure is to provide an LED retrofit lamp or module having a standard receptacle (e.g., NEMA receptacle), such that different control modules can be detachably coupled to the LED retrofit lamp or module, such that different control technologies can be used without having to replace or modify the LED retrofit lamp or module and/or the lighting fixture.

Generally, in one aspect, an LED retrofit lighting device comprises a light emitting assembly, a mounting interface (such as a screw base for LED retrofit lamps, or a mounting kit for LED retrofit modules) at a first portion of the light emitting assembly, a receptacle at a second portion of the light emitting assembly, the receptacle having a plurality of electrical contact points, and a control module detachably coupled to the receptacle.

In various embodiments, the light emitting assembly comprises a chassis and one or more light emitters disposed on the chassis.

In various embodiments, the chassis is structurally strong enough to support the control module on the second portion of light emitting assembly

In various embodiments, a first set of the electrical contact points of the receptacle is configured to provide electrical power from the light emitting assembly to the control module, and a second set of the electrical contact points of the receptacle is configured to transmit control signals from the control module to the light emitting assembly, thereby achieving one or more functionalities including dimming, sensor control, scheduling, and power metering.

In various embodiments, the control module comprises an antenna for receiving control signals and a control unit to process the received control signals, thereby controlling lighting effects of the light emitting assembly.

In various embodiments, the control module comprises an optical sensor for detecting ambient lighting conditions, and a control unit for generating control signals in response to the detected lighting condition, thereby controlling lighting effects of the light emitting assembly.

In another aspect, a lighting fixture comprises a base mount including a supporting site, a housing disposed on the base mount, and a LED retrofit lighting device enclosed within a chamber space defined by the base mount and the housing.

In various embodiments, the LED retrofit lighting device comprises a light emitting assembly, a mounting interface (such as a screw base for LED retrofit lamp, or a mounting kit for a LED retrofit module) at a first portion of the light emitting assembly, a receptacle at a second portion of the light emitting assembly, and a control module detachably coupled to the receptacle. The mounting interface may be securely engaged with the supporting site. The lighting fixture may further comprise a pole on which the base mount is disposed.

### BRIEF DESCRIPTION OF THE DRAWINGS

In the drawings, like reference characters generally refer to the same or similar parts throughout the different views. Also, the drawings are not necessarily to scale, emphasis instead generally being placed upon illustrating the principles of the invention.

FIG. 1 illustrates a lighting fixture enclosing an LED retrofit lamp having a control module, in accordance with an embodiment of the present disclosure.

FIG. 2A is a photograph showing an LED retrofit lamp having a control module coupled with a light emitting assembly, in accordance with an embodiment of the present disclosure.

FIG. 2B is a photograph showing a control module detached from a control receptacle on a light emitting assembly, in accordance with an embodiment of the present disclosure.

FIG. 3A is a photograph showing a decorative lighting fixture having a pole, a mount base, and a globe, in accordance with an embodiment of the present disclosure.

FIG. 3B is a photograph showing the decorative lighting fixture with the globe being removed from the post top, in accordance with an embodiment of the present disclosure.

FIG. 4A schematically illustrates an LED retrofit module, in accordance with an embodiment of the present disclosure.

FIG. 4B is a photograph showing an LED retrofit module, in accordance with an embodiment of the present disclosure.

### DETAILED DESCRIPTION

The present disclosure provides a retrofit solution for existing lighting fixtures, which includes an LED retrofit lamp/module with standard NEMA control receptacle, and a detachable control module. Such solution may be installed inside the lighting fixture without affecting the original appearance of the lighting fixture. The LED retrofit lamp/module replaces existing light source with preferred lighting performance, while the control module can be plugged into the control receptacle, such that the LED retrofit lamp/module can be connected for wireless remote control. The control module can be easily detached and exchanged with another control module having other control functions, or with an upgraded control module with the latest control technologies. As a result, existing lighting fixtures can achieve the latest control function or being connected without the need to replace the lighting fixtures or the LED retrofit lamp/module.

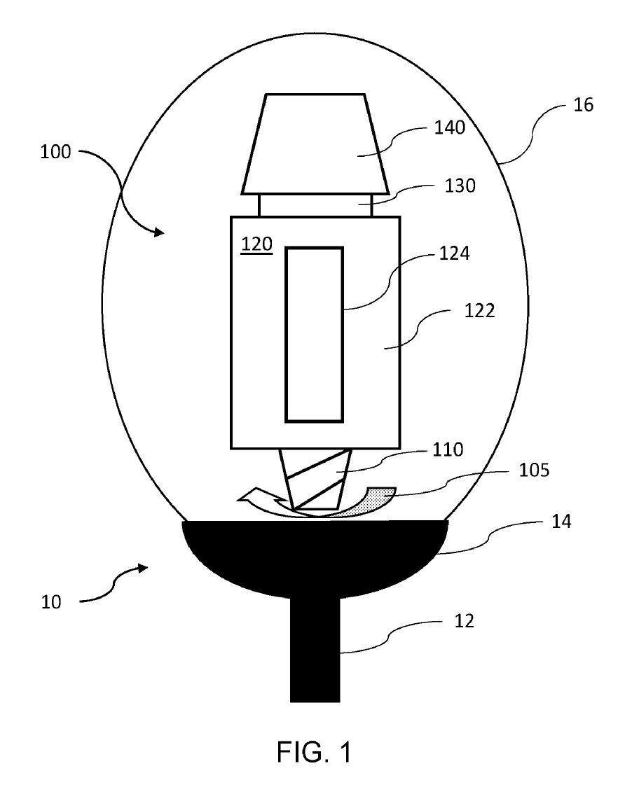

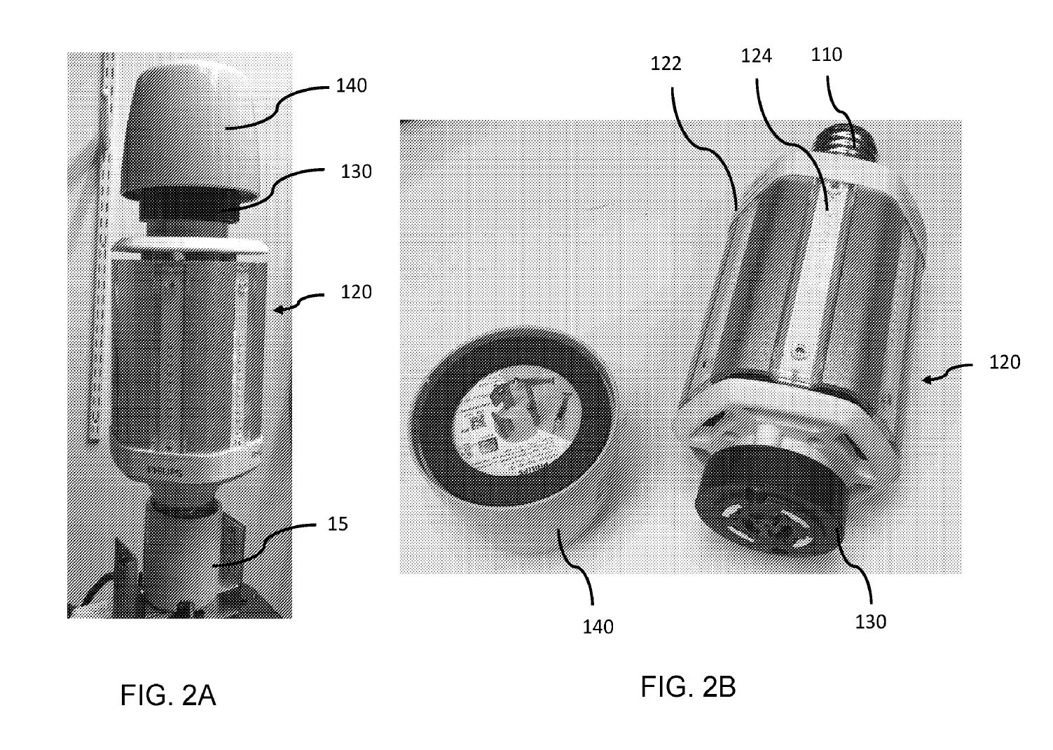

FIG. 1 illustrates a lighting fixture 10 enclosing an LED retrofit lamp 100 having a control module 140, in accordance with an embodiment of the present disclosure. FIG. 2A is a photograph showing LED retrofit lamp 100 having control module 140 coupled with a light emitting assembly 120, in accordance with an embodiment of the present disclosure. FIG. 2B is a photograph showing control module 140 detached from a control receptacle 130 on light emitting assembly 120, in accordance with an embodiment of the present disclosure.

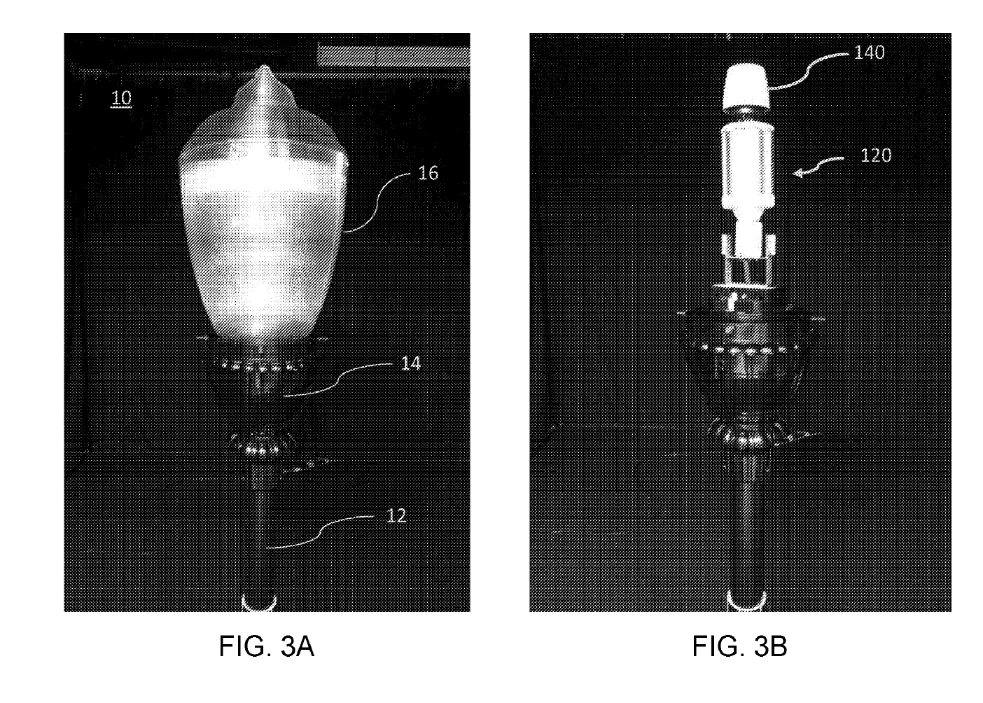

FIG. 3A is a photograph showing a decorative lighting fixture 10 having a pole 12, a mount base 14, and an enclosure 16 (such as a globe), in accordance with an embodiment of the present disclosure. FIG. 3B is a photograph showing decorative lighting fixture 10 with globe 16 being removed, in accordance with an embodiment of the present disclosure.

Referring to FIGS. 1, 2A, 2B, 3A, and 3B, lighting fixture 10 is a decorative post top comprising a pole 12 installed at an outdoor location, a mount base 14 disposed on pole 12 to provide a supporting site 15 (such as, a lamp socket 15) for receiving a light emitting device, which can be a conventional light bulb or a retrofit lamp, and a housing 16 disposed on mount base 14. In this embodiment, housing 16 comprises an enclosure such as a glass globe. It is appreciated that other types of decorative housings (e.g., a flat panel enclosure and any other enclosures of a suitable geometrical shape) may be used for lighting fixture 10. In this embodiment, housing 16 and mount base 14 define a chamber space to enclose the light source therein. It is appreciated that lighting fixture 10 may be a wall light fixture that does not require pole 12.

As shown in FIGS. 1, 2A, and 2B, LED retrofit lamp 100 comprises a light emitting assembly 120, a mounting interface 110 (e.g., a screw base or Edison screw) coupled to a bottom portion of light emitting assembly 120, a control receptacle 130 coupled to a top portion of light emitting assembly 120, and a control module 140 detachably coupled to control receptacle 130. LED retrofit lamp 100 can be rotated along an arrow direction 105, so as to securely engage mounting interface 110 with supporting site 15 of mount base 14. In this embodiment, LED retrofit lamp 100 is suitably sized to be completely enclosed within the chamber space defined by housing 16 and mount base 14. In this manner, customized control functions (e.g., remotely controlled dimming) can be added to LED retrofit lamp 100 without modifying lighting fixture 10 and without having to change/replace light emitting assembly 120.

In one embodiment, light emitting assembly 120 comprises a chassis 122 and one or more light emitters 124. Chassis 122 comprises a metal, plastic, or other suitable hard solid material that is structurally strong enough to support control module 140 on the top portion of light emitting assembly 120. In this embodiment, light emitters 124 comprise an array of LED devices. It is appreciated that other suitable light sources can be used for light emitters 124. In one embodiment, LED retrofit lamp 100 further includes integrated optics (not shown) and a ballast (e.g., external ballast or integrated self-ballast) directly or indirectly connected to the main power line through mounting interface 110.

In one embodiment, receptacle 130 is a standard NEMA control receptacle. The NEMA control receptacle may have a plurality of electrical contact points, e.g., 3 pins, 5 pins, 7 pins, etc. Control module 140 can be electrically coupled to light emitting assembly 120 through a first set of the electrical contact points of receptacle 130, so as to share the AC power supply with light emitting assembly 120. Additionally, control module 140 can be detachably combined with receptacle 130 by, for example, rotating or twisting the control module 140 for about 25-60 degrees, so as to provide control signals to light emitting assembly 120 through a second set of the electrical contact points of receptacle 130, thereby controlling the lighting effects (e.g., dimming, turn on/off, etc.) of light emitting assembly 120. Depending on the actual usage cases, control module 140 can wirelessly receive the control signals transmitted from a remote site. Alternatively, control module 140 can generate control signals autonomously in response to changes of the ambient environment (e.g., change of environmental light intensity, humidity, temperature, etc.) surrounding lighting fixture 10.

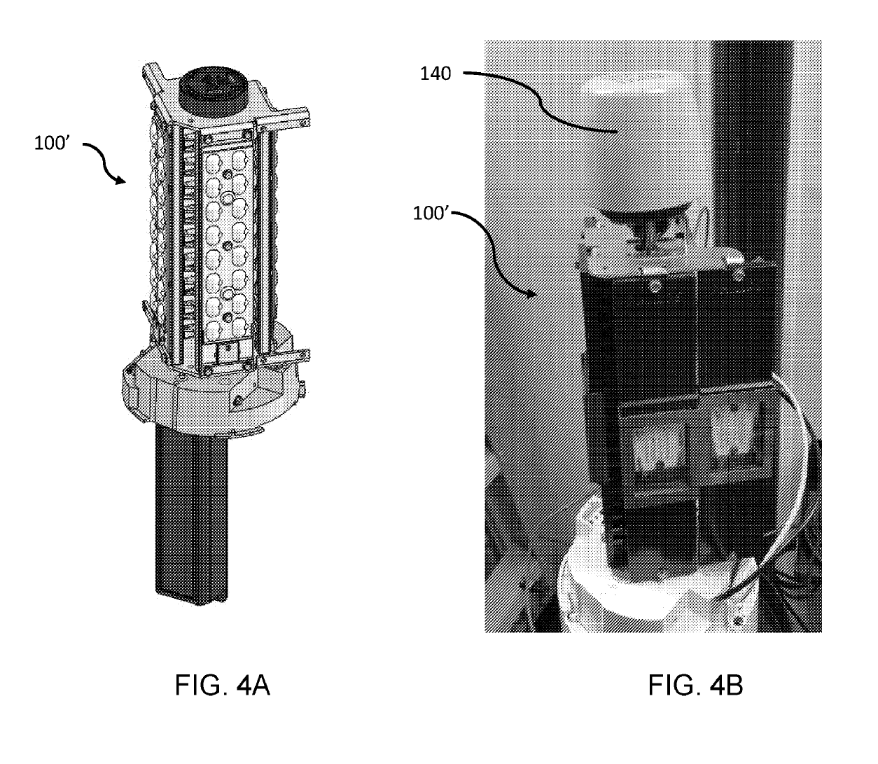

Referring to FIGS. 4A and 4B, there is illustrated an LED retrofit module 100′ in accordance with another embodiment of the present disclosure. In various embodiments, LED retrofit module 100′ may include LED light engines, optics, heat sink, mounting bracket or interface, external ballast, NEMA receptacle, and a wireless control module 140 (e.g., CityTouch of Philips). Control module 140 may work as an individual node connected to a lighting network or controlled directly by a customer. LED retrofit module 100′ can be turned on/off, scheduled for energy saving, dimmed, energy monitoring, photo cell controlled using control module 140. Unlike LED retrofit lamp 100, LED module 100′ does not include a screw shell base. Instead, LED retrofit module 100′ employs a mounting interface, such as a bracket, so as to be installed and mounted to a lighting fixture.

In various embodiments, control module 140 can be a simple photo-cell control module, or any other more complex control modules that provide wireless control, dimming control, motion control, dusk-to-dawn, internet connection (e.g., a WiFi hotspot, cellular connectivity having GPS positioning and compatibility to connect to the cloud via cellular data network, etc.), and other sensor technologies integrated therein. Moreover, control module 140 can work as an individual node for a more complicated lighting network.

In one embodiment, control module 140 includes an antenna for receiving control signals and a control unit to process the received control signals, thereby controlling the lighting effects of the light emitting assembly 120. In another embodiment, control module 140 includes an optical sensor for detecting the ambient lighting conditions, and a control unit for generating control signals in response to the detected lighting condition, thereby controlling the lighting effects of the light emitting assembly 120. In a further embodiment, control module 140 includes a motion sensor for detecting the existence of moving subject proximate LED retrofit lighting device 100 or lighting fixture 10, and a control unit for generating control signals in response to the detection of the moving subject, thereby turning ON and/or OFF the light emitting assembly 120 in accordance with a desired design.

The LED retrofit lamps/modules of the present disclosure can be used in various applications. For example, the LED retrofit lamps/modules of the present disclosure can be used for residential pedestrian lighting (post-top), street lighting (roadway), area lighting, parking lighting, indoor/outdoor high bay, etc. In such applications, the lighting fixture should have a suitable dimension such that the LED retrofit lamps/modules can be installed and enclosed inside the lighting fixture without interfering the original look and feel of the lighting fixture.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical values appeared in this specification are deemed modified by a term of degree thereby reflecting their intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

1. An LED retrofit lighting device, comprising:
a light emitting assembly;
a mounting interface at a first portion of the light emitting assembly for connecting the light emitting assembly with an external power source;
a receptacle at a second portion of the light emitting assembly, the receptacle having a plurality of electrical contact points; and
a control module detachably coupled to the receptacle;
wherein a first set of the electrical contact points of the receptacle is configured to provide electrical power from the light emitting assembly to the control module, and a second set of the electrical contact points of the receptacle is configured to transmit control signals from the control module to the light emitting assembly.

2. The LED retrofit lighting device of claim 1, wherein the light emitting assembly comprises a chassis and one or more light emitters disposed on the chassis.

3. The LED retrofit lighting device of claim 2, wherein the chassis is structurally strong enough to support the control module on the second portion of light emitting assembly

4. The LED retrofit lighting device of claim 1, wherein the control module comprises an antenna for receiving control signals and a control unit to process the received control signals, thereby controlling lighting effects of the light emitting assembly.

5. The LED retrofit lighting device of claim 1, wherein the control module comprises an optical sensor for detecting ambient lighting conditions, and a control unit for generating control signals in response to the detected lighting condition, thereby controlling lighting effects of the light emitting assembly.

6. The LED retrofit lighting device of claim 1, wherein the control module comprises a motion sensor for detecting the existence of a moving subject proximate the LED retrofit lighting device, and a control unit for generating control signals in response to the detection of the moving subject.

7. The LED retrofit lighting device of claim 1, wherein the mounting interface comprises a screw base for a LED retrofit lamp

8. The LED retrofit lighting device of claim 1, wherein the mounting interface comprises a mounting kit for a LED retrofit module.

9. A lighting fixture, comprising:
a base mount including a supporting site;
a housing disposed on the base mount; and
a LED retrofit lighting device enclosed within a chamber space defined by the base mount and the housing,
wherein the LED retrofit lighting device comprises:
a light emitting assembly;
a mounting interface at a first portion of the light emitting assembly for connecting the light emitting assembly with an external power source;
a receptacle at a second portion of the light emitting assembly; and
a control module detachably coupled to the receptacle.

10. The lighting fixture of claim 9, wherein the mounting interface is securely engaged with the supporting site.

11. The lighting fixture of claim 9, further comprising a pole on which the base mount is disposed.

12. The LED retrofit lighting device of claim 1, wherein the receptacle comprises a standard NEMA control receptacle.

13. The LED retrofit lighting device of claim 1, wherein the electrical power comprises an AC electric power source.

14. The LED retrofit lighting device of claim 1, wherein the control module detachably coupled to the receptacle by rotation of about 25-60 degrees.

15. The lighting fixture of claim 9, wherein the control module is detachably coupled to the receptacle by rotation of about 25-60 degrees.

16. The lighting fixture of claim 9, wherein the receptacle has a plurality of electrical contact points.

17. The lighting fixture of claim 16, wherein a first set of the electrical contact points of the receptacle is configured to provide electrical power from the light emitting assembly to the control module, and a second set of the electrical contact points of the receptacle is configured to transmit control signals from the control module to the light emitting assembly.

18. The lighting fixture of claim 17, wherein the electrical power comprises an AC electric power source.

19. The lighting fixture of claim 9, wherein the control module is detachably coupled to the receptacle by rotation.

20. The LED retrofit lighting device of claim 1, wherein the control module is detachably coupled to the receptacle by rotation.
